(19) United States
(12) Patent Application Publication
(10) Pub. No.: US 2016/0209579 A1
(43) Pub. Date: Jul. 21, 2016

(54) DISPLAY APPARATUS

(71) Applicant: Samsung Display Co., Ltd., Yongin-si (KR)

(72) Inventors: Cheuljin PARK, Seoul (KR); Hyunchul BAE, Suwon-si (KR); Donghyeon LEE, Seoul (KR); Kwangwook CHOI, Osan-si (KR)

(21) Appl. No.: 14/884,154

(22) Filed: Oct. 15, 2015

(30) Foreign Application Priority Data
Jan. 16, 2015 (KR) 10-2015-0008247

(51) Int. Cl. F21V 8/00

(52) U.S. Cl. CPC G02B 6/0085; G02B 6/0068; G02B 6/0051; G02B 6/0055; G02B 6/0091

(57) ABSTRACT

Provided is a display apparatus including a display panel displaying an image, a light source generating light, a light guide plate receiving the light from the light source to guide the light to the display panel, and a heat dissipation member disposed adjacent to a side surface of the light guide plate, wherein the heat dissipation member includes an insertion part passing through the heat dissipation member to accommodate the light source and provide the light generated from the light source to the light guide plate.

### CLAIM OF PRIORITY

This U.S. non-provisional patent application claims the priority of and all the benefits accruing under 35 U.S.C. §119 of Korean Patent Application No. 10-2015-0008247, filed on Jan. 16, 2015 in the Korean Intellectual Property Office (KIPO), the entire contents of which are hereby incorporated by reference.

### BACKGROUND OF THE INVENTION

1. Field of Disclosure

The present disclosure herein relates to a display apparatus, and more particularly, to a display apparatus having a reduced bezel area.

2. Description of the Related Art

In general, a display apparatus includes a display panel displaying an image and a backlight unit supplying light to the display panel. The display panel adjusts transmittance of the light supplied from the backlight unit to display an image.

The backlight unit may be classified into an edge type backlight unit disposed on a side surface of the display panel to supply light to the display panel and a direct type backlight unit disposed under the display panel to supply light to the display panel. The edge type backlight unit includes a light source generating light and a light guide plate guiding a direction of the light. The light source is disposed on a side of the light guide plate, and the light guide plate guides the light generated from the light source to the display panel.

The backlight unit and the display panel may be accommodated between and fixed to bottom and top chassis. The bottom and top chassis may protect the backlight unit and the display panel.

### SUMMARY OF THE INVENTION

The present disclosure provides a display apparatus having a reduced bezel area.

In general, a display apparatus includes a display panel displaying an image and a backlight unit supplying light to the display panel. The display panel adjusts transmittance of the light supplied from the backlight unit to display an image.

The backlight unit may be classified into an edge type backlight unit disposed on a side surface of the display panel to supply light to the display panel and a direct type backlight unit disposed under the display panel to supply light to the display panel. The edge type backlight unit includes a light source generating light and a light guide plate guiding a direction of the light. The light source is disposed on a side of the light guide plate, and the light guide plate guides the light generated from the light source to the display panel.

The backlight unit and the display panel may be accommodated between and fixed to bottom and top chassis. The bottom and top chassis may protect the backlight unit and the display panel.

Embodiments of the inventive concept provide display apparatuses including a display panel displaying an image; a light source generating light; a light guide plate receiving the light from the light source to guide the light to the display panel; and a heat dissipation member disposed adjacent to a side surface of the light guide plate, wherein the heat dissipation member includes an insertion part passing through the heat dissipation member to accommodate the light source and provide the light generated from the light source to the light guide plate.

In some embodiments, the insertion part may extend along a side surface of the light guide plate.

In other embodiments, the light source may include a light source substrate disposed adjacent to a side surface of the light guide plate to extend along a side surface of the light guide plate; and a plurality of light source units mounted on the light source substrate.

In still other embodiments, the insertion part may include an accommodation groove in which the light source substrate is mounted; a first hole formed in the accommodation groove and into which the light source units are inserted; and a second hole connected to the first hole to provide the light provided from the light source units to the light guide plate.

In even other embodiments, the heat dissipation member may include a first extension part extending upward; and a second extension part extending horizontally from a lower end of the first extension part, wherein the first extension part and the second extension part extend in a first direction in which the first extension part and the second extension part extend along a side of the light guide plate, and the insertion part passes through the first extension part of the heat dissipation member in a second direction that is perpendicular to the first direction to extends horizontally.

In yet other embodiments, the display apparatus may further include a reflection sheet disposed below the light guide plate to reflect light emitted to a lower side of the light guide plate upward.

In further embodiments, the display apparatus may further include an optical member disposed above the light guide plate to diffuse and collect the light provided from the light guide plate, thereby providing the light to the display panel.

In still further embodiments, the display apparatus may further include an accommodation member accommodating the light source, the light guide plate, the heat dissipation member, the optical member, and the reflection sheet.

In even further embodiments, the accommodation member may include a bottom part disposed below the reflection sheet; and a plurality of sidewall parts connected to the bottom part, wherein the light source and the heat dissipation member are disposed on an inner side surface of one of the sidewall parts.

In yet further embodiments, the light source units may be mounted on a front surface of the light source substrate, which faces a side surface of the light guide plate, and a rear surface of the light source substrate may contact an inner surface of one of the sidewall parts of the accommodation member.

In much further embodiments, the display apparatus may further include a mold frame disposed above the light guide plate and the heat dissipation member and have a frame shape surrounding edge areas of an optical member and the display panel, wherein the optical member and the display panel are seated inside the frame shape of the mold frame.

In still much further embodiments, the mold frame may include a first vertical part contacting the sidewall part of the accommodation member to extend along the sidewall part; a second vertical part disposed below the first vertical part to extend parallel to the first vertical part; a first horizontal part connected to a lower end of the first vertical part and an upper end of the second vertical part to extend horizontally along the sidewall part of the accommodation member; and a second horizontal part connected to a lower end of the second vertical part to extend horizontally along an edge of a top surface of the light guide plate, wherein the first vertical part, the second vertical part, the first horizontal part, and the second horizontal part are connected to form a stair shape, the display panel is seated on a top surface of the first horizontal part, and the optical member is seated on a top surface of the second horizontal part.

In even much further embodiments, the display apparatus may further include a cover member disposed above the display panel, wherein the cover member includes a first cover part surrounding an edge area of the display panel; a second cover part connected to the first cover part to surround the sidewall parts of the accommodation member; and an open part disposed inside the first cover part to expose the display area of the display panel, wherein the first cover part is connected to the second cover parts to form the frame shape surrounding the display panel, the backlight unit, the mold frame, and the accommodation member.

In yet much further embodiments, the heat dissipation member may be connected to the mold frame to form one body.

In much still further embodiments, the second hole may gradually increase in size in a vertical direction from the light source unit toward the light guide plate.

In even still further embodiments, the heat dissipation member may include an accommodation groove in which the light source substrates are mounted; a plurality of first holes formed in the accommodation groove, disposed to be spaced the same distance from each other along a side of the light guide plate, and into which the light source units are inserted; and a second hole connected to the first holes to provide light provided from the light source units to the light guide plate, wherein the accommodation groove, the first holes, and the second hole are connected to each other to pass through the heat dissipation member.

In yet still further embodiments, the heat dissipation member may include metal, and a damage prevention tape may be attached between the light guide plate and the heat dissipation member.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view of a display apparatus according to an embodiment of the inventive concept;

FIG. 2 is an enlarged perspective view of a heat dissipation member according to the embodiment of the inventive concept;

FIG. 3 is a cross-sectional view taken along line I-I′ of FIG. 1;

FIG. 4 is an enlarged perspective view of a heat dissipation member according to another embodiment of the inventive concept; and

FIG. 5 is a cross-sectional view of a display apparatus according to another embodiment of the inventive concept.

### DETAILED DESCRIPTION OF THE INVENTION

Advantages and features of the inventive concept, and implementation methods thereof will be clarified through following embodiments described with reference to the accompanying drawings. Embodiments of the inventive concept may, however, be embodied in many different forms and should not be construed as being limited to the embodiments set forth herein. Rather, these embodiments are provided so that this disclosure will be thorough and complete, and will fully convey the concept of the invention to those skilled in the art. Further, the present disclosure is only defined by scopes of claims. Like reference numerals refer to like elements throughout.

These terms are only used to distinguish one element from another element. It will also be understood that when an element (or layer) is referred to as being “on” another layer or element, it can be directly on the other layer or element, or intervening layers or elements may also be present. Also, it will be understood that when an element is referred to as being “directly on” or “right on” another element, it can be directly on the other element or no intervening constituent element or layer is present. As used herein, the term “and/or” includes any and all combinations of one or more of the associated listed items.

Spatially related terms, such as “beneath”, “below”, “lower”, “above”, “upper” and the like, are used herein for ease of description to describe one element or feature's relationship to another element(s) or feature(s) as illustrated in the figures. It is understood that the spatially related terms are intended to encompass different orientations of the device in use or operation in addition to the orientation depicted in the figures. Like reference numerals refer to like elements throughout.

Also, though terms like a first and a second are used to describe various members, components, regions, layers, and/or portions in various embodiments of the inventive concept, the members, components, regions, layers, and/or portions are not limited to these terms. These terms are used only to differentiate one member, component, region, layer, or portion from another one. Therefore, a member, a component, a region, a layer, or a portion referred to as a first member, a first component, a first region, a first layer, or a first portion in an embodiment can be referred to as a second member, a second component, a second region, a second layer, or a second portion in another embodiment.

The embodiments in the detailed description will be described with sectional views and/or plan views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate a specific shape of a semiconductor package region. Thus, this should not be construed as limited to the scope of the inventive concept.

Hereinafter, preferred embodiments of the inventive concept will be described below in more detail with reference to the accompanying drawings.

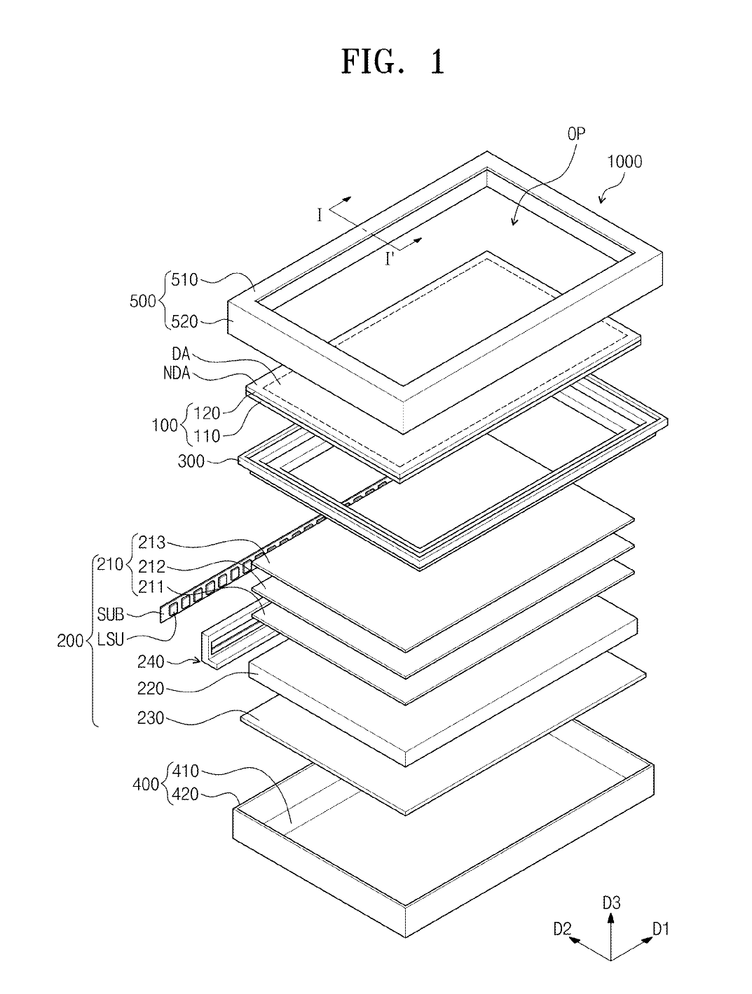

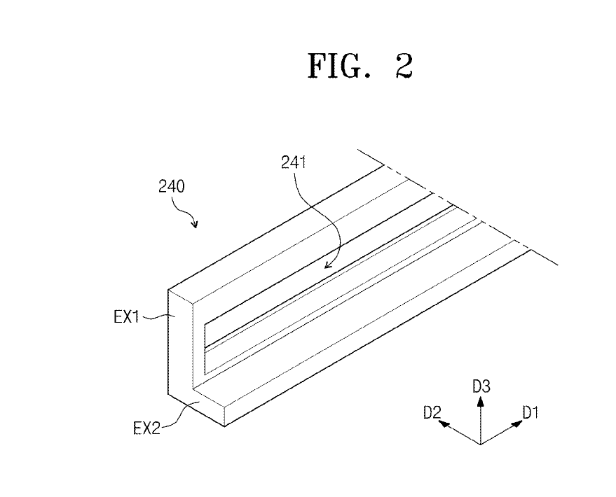

FIG. 1 is an exploded perspective view of a display apparatus according to an embodiment of the inventive concept, and FIG. 2 is an enlarged perspective view of a heat dissipation member according to the embodiment of the inventive concept.

Referring to FIGS. 1 and 2, a display apparatus 1000 according to an embodiment of the inventive concept includes a display panel 100, a backlight unit 200, a mold frame 300, an accommodation member 400, and a cover member 500.

The display panel 100 may be a liquid crystal display panel. That is, the display panel 100 may include a display substrate 110 on which a plurality of pixels (not shown) displaying an image by using light provided from the backlight unit 200 are disposed and an opposite substrate 120 disposed to face the display substrate 110. Although not shown, the display panel 100 may include a liquid crystal layer (not shown) disposed between the display substrate 110 and the opposite substrate 120.

An area on a plane of the display panel 100 includes a display area DA on which the pixels (not shown) are disposed and a non-display area NDA around the display area DA.

The backlight unit 200 is disposed at a rear side of the display panel 100 to provide light to the display panel 100.

The backlight unit 200 may be an edge type backlight unit. The backlight unit 200 includes a light source LS, an optical member 210, a light guide plate 220, a reflection sheet 230, and a heat dissipation member 240.

Each of the display panel 100, the optical member 210, the light guide plate 220, and the reflection sheet 230 may have a long side in a first direction D1 and a short side in a second direction D2 that is intersects with the first direction D1.

The light source LS is disposed adjacent to a side of the light guide plate 220 in the second direction D2. The reflection sheet 230 is disposed below the light guide plate 220, and the optical member 210 is disposed above the light guide plate 220. The display panel 100 is disposed above the optical member 220.

The light source LS generates light to be provided to the display panel 100 to supply the light to the light guide plate 220. The light source LS includes a light source substrate SUB and a plurality of light source units LSU mounted on the light source substrate SUB.

The light source substrate SUB extends in the first direction D1. The light source units LSU are disposed on a side of the light source substrate SUB in the second direction D2. The light source units LSU may be disposed to be spaced a predetermined distance from each other in the first direction D1.

The light source units LSU generate light. The light generated from the light source units LSU is supplied to the light guide plate 220.

The light guide plate 220 changes a traveling direction of the light provided from the light source units LSU toward an upward direction in which the display panel 100 is disposed. Although not shown, the light guide plate 220 may have a bottom surface in which a pattern or groove is formed to scatter incident light and a top surface on which a pattern having a lens or groove shape is formed. The groove shape can be a rectangular shape with right-angled corners or rounded corners, or an irregular shape.

The light source plate 220 includes a material having high optical transmittance in a visible light region. For example, the light source plate 220 may include PMMA (polymethylmethacrylate).

The optical member 210 is disposed above the light guide plate 220. The optical member 210 includes a diffusion sheet 211, a prism sheet 212, and a protection sheet 213. The light guided in the upward direction by the light guide plate 220 may be diffused and collected by the optical member 210 and then supplied to the display panel 100.

In detail, the diffusion sheet 211 diffuses the light provided from the light guide plate 220. The prism sheet 212 collects the light diffused by the diffusion sheet 211 in the upward direction that is perpendicular to the plane. The light passing through the prism sheet 212 advances in the upward direction and supplied to the display panel 100 with uniform brightness distribution. The protection sheet 213 protects the prism sheet 212 from external friction.

The reflection sheet 230 is disposed below the light guide plate 220. The reflection sheet 230 reflects light emitted to a lower side of the light guide plate 130 upward. The reflection sheet 230 includes a light reflecting material. For example, the reflection sheet 230 may include aluminum and polyethylene terephthalate PET.

The accommodation member 400 includes a bottom part 410 and a plurality of sidewall parts 420 connected to the bottom part 410. The accommodation member 400 accommodates the backlight unit 200. In an embodiment of the inventive concept, the light source LS and the heat dissipation member 240 may be disposed on an inner side surface of one of the sidewall parts 420 of the accommodation member 400.

The heat dissipation member 240 is disposed between the light guide plate 220 and the accommodation member 400. In detail, the heat dissipation member 240 is disposed between a side surface of the light guide plate 220 and the inner side surface of the sidewall part 420, which faces the side surface of the light guide plate 220, of the sidewall parts 420 of the accommodation member 400 in the second direction D2. Here, the heat dissipation member 240 emits heat generated from the light source LS to the outside. The heat dissipation member 240 may include aluminum.

The heat dissipation member 240 extends in the first direction D1. Specifically, the heat dissipation member 240 may extend to correspond to a length of the light source substrate SUB in the first direction D1.

The heat dissipation member 240 has an “L”-shaped cross-section. In detail, the heat dissipation member 240 may include a first extension part EX1 extending upward and a second extension part EX2 extending from a lower end of the first extension part EX1 in the second direction D2.

The heat dissipation member 240 includes an insertion part 241. The light source units LSU and the light source substrate SUB may be inserted into the insertion part 241 of the heat radiating part 240. In detail, the light source units LSU and the light source substrate SUB may be inserted into and coupled to the insertion part 241 in a direction from the accommodation member 400 toward the light guide plate 220.

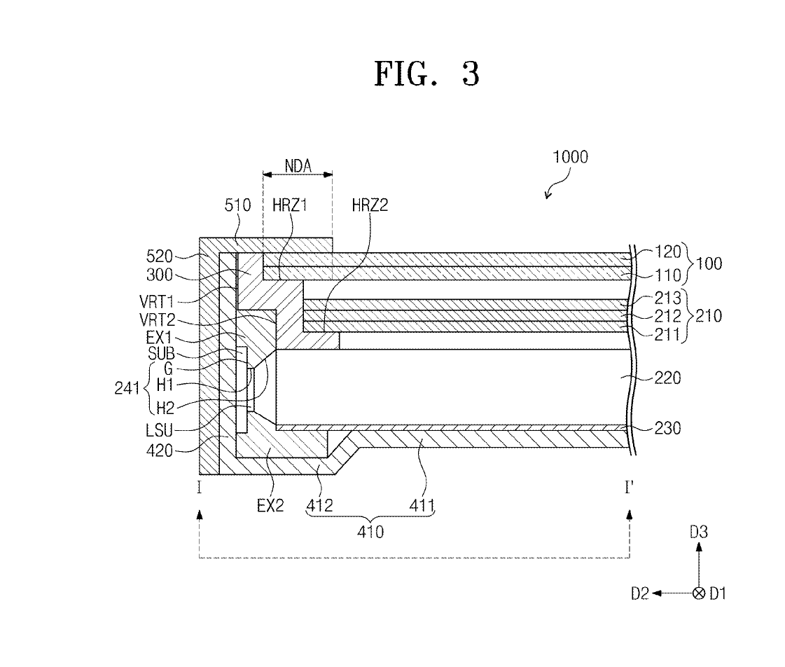

The insertion part 241 includes an accommodation groove G, a first hole H1, and a second hole H2. The insertion part 241 will be described in more detail with reference to FIG. 3. The shape of the groove G can be a rectangular shape with right-angled corners or rounded corners (not shown), an elliptical shape (not shown), a sausage shape (not shown), or an irregular shape (not shown).

The mold frame 300 is disposed above the heat dissipation member 240 and the light guide plate 220. The mold frame 300 has a predetermined frame shape. The mold frame 300 may be disposed to correspond to an edge area on a top surface of the light guide plate 220. The mold frame 300 fixes the heat dissipation member 240, the light guide plate 220, the optical member 210, and the display panel 100.

The cover member 500 is disposed above the display panel 100. The cover member 500 has a frame shape. The cover member 500 includes a first cover part 510 disposed above the display panel 100 to cover the non-display area NDA of the display panel 100, a second cover part 520 defining a sidewall of the cover member 500, and an open part OP disposed inside the first cover part 510 to expose the display area DA of the display panel 100.

The second cover part 520 is connected to the outside of the first cover part 510 to extend downward. That is, the first cover part 510 and the second cover part 520 may be disposed perpendicular to each other. The second cover part 520 surrounds outer side surfaces of the accommodation member 400.

FIG. 3 is a cross-sectional view taken along line I-I′ of FIG. 1.

Referring to FIG. 3, the non-display area NDA of the display panel 100 may be fixedly disposed between the first cover part 510 and the mold frame 300. In detail, a top surface of the non-display area NDA of the display panel 100 may contact the first cover part 510 of the cover member 500, and a bottom surface of the non-display area NDA of the display panel 100 may fixedly contact a mold frame 300.

A second cover part 520 of the cover member 500 surrounds outer side surfaces of sidewall parts 420 of the accommodation member 400. In detail, the second cover parts 520 have the inner side surface contacting the outer side surfaces of the sidewall parts 420 of the accommodation member 400.

The mold frame 300 has a frame shape surrounding an edge area of each of the optical member 220 and the display panel 100. The mold frame 300 is disposed to correspond to an edge area of a top surface of the light guide plate 220 to fix the light guide plate 220 to a bottom part 410 of the accommodation member 400 without moving.

The mold frame 300 has a stair-shaped cross-section. The mold frame 300 includes a first horizontal part HRZ1, a second horizontal part HRZ2, a first vertical part VRT1, and a second vertical part VRT2.

The first horizontal part HRZ1 and the second horizontal part HRZ2 extend in a horizontal direction that is perpendicular to an extension direction of the first vertical part VRT1 and the second vertical part VRT2.

In detail, the first horizontal part HRZ1 is connected to a lower end of the first vertical part VRT1 and an upper end of the second vertical part VRT2 to horizontally extend along the sidewall part 420 of the accommodation member 400. The second horizontal part HRZ2 is connected to a lower end of the second vertical part VRT2 to horizontally extend along an edge of a top surface of the light guide plate 220.

The optical member 220 and the display panel 100 may be seated inside the frame shape of the mold frame 300. In detail, the display panel 100 may be seated on a top surface of the first horizontal part HRZ1. The optical member 210 may be seated on a top surface of the second horizontal part HRZ2.

The mold frame 300 has the stair shape in which the first horizontal part HRZ1, the second horizontal part HRZ2, the first vertical part VRT1, and the second vertical part VRT2 are connected to each other to form a stepped portion between the light guide plate 220 and the optical member 210 seated inside the mold frame 300. That is, the light guide plate 220 and the optical member 210 may be disposed to be spaced apart from each other without contacting each other.

A light source substrate SUB is disposed on the inner side surface of the accommodation member 400. In detail, the optical units LSU are mounted on a front surface of the optical source substrate SUB, and a rear surface of the light source substrate SUB contacts the inner side surface of the sidewall part 420, which faces a side surface of the light guide plate 220. The light source units LSU are disposed along a side surface of the light guide plate 220 to face the side surface of the light guide plate 220. Accordingly, light provided from the light source units LSU may be incident into the light guide plate 220 through the side surface of the light guide plate 220.

The bottom part 410 of the accommodation member 400 includes a first bottom part 411 and a second bottom part 412. The first bottom part 411 has a rectangular shape. The second bottom part 412 is disposed on a side of the bottom part 410 in the second direction D2. The second bottom part 412 is disposed below the heat dissipation member 240 and connected to the first bottom part 412 to form one body with the first bottom part 412.

The first bottom part 411 is disposed higher than the second bottom part 412. That is, a predetermined area of a side of the bottom part 410 is recessed downward in the second direction D2 to from the second bottom part 412.

The first bottom part 411 of the accommodation member 400 contacts a bottom surface of the reflection sheet 230. The second bottom part 412 of the accommodation member 400 contacts a bottom surface of the second extension part EX2 of the heat dissipation member 240. The sidewall parts 420 of the accommodation member 400 fix the rear surface of the light source substrate SUB and side surfaces of the light guide plate 220 except for a side surface of the light guide plate 220 facing the light source substrate SUB.

The heat dissipation member 240 is disposed at a side of the light guide plate 220 in the second direction D2.

In detail, the first extension part EX1 of the heat dissipation member 240 is disposed between a side of the light guide plate 220 and the sidewall part 420 of the accommodation member 400 in the second direction D2. The second extension part EX2 of the heat dissipation member 240 is disposed between the reflection sheet 230 disposed below the light guide plate 220 and the second bottom part 410 of the accommodation member 400.

The first extension part EX1 and the second extension part EX2 extend in the first direction D1. Also, the first extension part EX1 extends upward, and the second extension part EX2 is connected to a lower end of the first extension part to extend in the second direction D2.

A top surface of the first extension part EX1 of the heat dissipation member 240 contacts a predetermined area of a bottom surface of the first horizontal part HRZ2 of the mold frame 300. A side surface of the first extension part EX1 contacts a predetermined area of the inner side surface of the sidewall part 420 which faces a side surface of the light guide plate 220 in the second direction D2. A top surface of the second extension part EX2 of the heat dissipation member 240 contacts an edge area of a side of a bottom surface of the reflection sheet 230, which corresponds to a side of the light guide plate 220, and a bottom surface of the second extension part EX2 contacts the second bottom part 412 of the accommodation member 400.

The insertion part 241 of the heat dissipation member 240 is formed in the first extension part EX1 of the heat dissipation member 240. The insertion part 241 includes an accommodation groove G, a first hole H1, and a second hole H2.

The accommodation groove G is defined by being recessed from one side surface toward the other surface of the first extension part EX1 in the second direction D2. The accommodation groove G extends in the first direction D1.

The light source substrate SUB may be inserted into the accommodation groove G. In detail, a front surface of the optical source substrate SUB, on which optical units LSU are mounted, may be inserted into the accommodation groove G of the heat dissipation member 240, and the rear surface of the light source substrate SUB may contact the inner side surface of the sidewall part 420 of the accommodation member 400.

The accommodation groove G is connected to the first hole H1. The first hole H1 passes through the first extension part EX1 in the second direction D2 in the accommodation groove G. The first hole H1 extends in the first direction D1. The light source units LSU may be inserted into the first hole H1.

The first hole H1 is connected to the second hole H2. The second hole H2 passes through the first extension part EX1 in the second direction D2. The second hole H2 extends in the first direction D1. The second hole H2 provides light generated from the light source units LSU to the light guide plate 220.

The second hole H2 may gradually increase in size in a vertical direction from the light source unit LSU toward the light guide plate 220. The second hole H2 having the size increasing in the vertical direction may have a maximum size to correspond to a vertical size of a side surface of the light guide plate 220 in the second direction D2.

The first hole H1 and the second hole H2 may have a rectangular shape having a long side in the first direction D1 and a short side in the vertical direction.

The first hole H1 may be separated into a plurality of holes H1 to be spaced apart from each other. In detail, the plurality of holes H1 may be spaced apart from the accommodation groove G. The first holes H1 may be spaced the same distance from each other in the first direction D1. The first holes H1 may be connected to the second hole H2.

Here, positions in which the first holes H1 are formed correspond to areas into which the optical units LSU are inserted. Accordingly, the light source units LSU may be inserted into the corresponding first holes H1, respectively.

In the display apparatus 1000 according to the embodiment of the inventive concept, since the heat dissipation member 240 having the insertion part 241 is disposed on the front surface of the optical source substrate SUB to insert the optical units LSU into the first and second holes H1 and H2 of the heat dissipation member 240, a bezel may be reduced in size.

Also, according to the embodiment of the inventive concept, as the optical units LSU are inserted into the first and second holes H1 and H2 of the heat dissipation member 240, light generated from the optical units LSU may not leak to the outside. That is, an amount of light provided to the light guide plate 220 from the light source units LSU may increase. Accordingly, the light provided to the display panel 100 may be improved in efficiency.

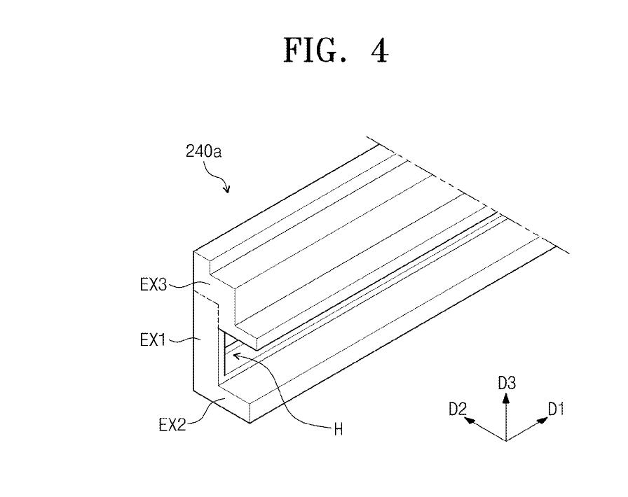

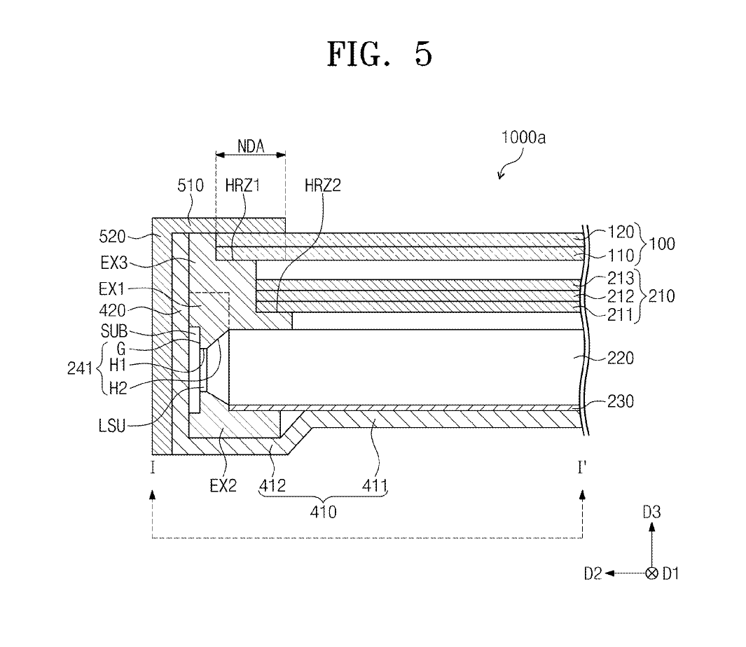

FIG. 4 is an enlarged perspective view of a heat dissipation member according to another embodiment of the inventive concept; and FIG. 5 is a cross-sectional view of a display apparatus according to another embodiment of the inventive concept.

Hereinafter, a display apparatus 1000a has the same constitution as the display apparatus 1000 of FIGS. 1 to 3 except for a heat dissipation member 240a. Accordingly, description for the constitutions of the display apparatus 1000a except for the heat dissipation member 240a will be omitted.

Referring to FIGS. 4 and 5, according to another embodiment of the inventive concept, the heat dissipation member 240a may be coupled to the mold frame 300 to form one body. The heat dissipation member 240a is disposed on an inner side surface of a sidewall part 420, which faces a side surface of a light guide plate 220.

The heat dissipation member 240a includes a first extension part EX1, a second extension part EX2, and a third extension part EX3.

The first extension part EX1 of the heat dissipation member 240a is disposed between a side of the light guide plate 220 and the sidewall part 420 of an accommodation member 400 in a second direction D2. The second extension part EX2 of the heat dissipation member 240a is disposed between a reflection sheet 230 disposed below the light guide plate 220 and a second bottom part 412 of the accommodation member 400.

The first extension part EX1 and the second extension part EX2 extend in a first direction D1. Also, the first extension part EX1 extends upward, and the second extension part EX2 is connected to a lower end of the first extension part EX1 to extend in the second direction D2.

A top surface of the first extension part EX1 of the heat dissipation member 240a contacts a predetermined area of a bottom surface of a first horizontal part HRZ2 of a mold frame 300. A side surface of the first extension part EX1 contacts a predetermined area of the inner side surface of the sidewall part 420, which faces a side surface of the light guide plate 220 in the second direction D2. A top surface of the second extension part EX2 of the heat dissipation member 240 contacts an edge area of a side of a bottom surface of a reflection sheet 230, which corresponds to a side of light guide plate 220, and a bottom surface of the second extension part EX2 contacts the second bottom part 412 of the accommodation member 400.

The third extension part EX3 has the same shape as the mold frame 300 in FIGS. 1 to 3. Accordingly, the heat dissipation member 240a may have one body because a side of a bottom surface of the third extension part EX3 is connected to a top surface of the first extension part EX1 in the second direction D2. The heat dissipation member 240a is disposed on the sidewall part 420 of the accommodation member 400.

The heat dissipation member 240a includes an insertion part 241a. The insertion part 241a is formed in the first extension part EX1 of the heat dissipation member 240. Hereinafter, since the insertion part 241a has the same constitution as the insertion part 241 according to the foregoing embodiment of the inventive concept, descriptions for the insertion part 241a will be omitted.

According to another embodiment of the inventive concept, since the heat dissipation member 240a is coupled to the mold frame 300 to form one body, the display apparatus 1000a may be improved in assemblability.

In the display apparatus 1000a according to another embodiment of the inventive concept, since the heat dissipation member 240 having the insertion part 241 is disposed on a front surface of the optical source substrate SUB to insert the optical units LSU into the first and second holes H1 and H2 of the heat dissipation member 240, a bezel may be reduced in size.

Also, according to another embodiment of the inventive concept, as the optical units LSU are inserted into the first and second holes H1 and H2 of the heat dissipation member 240, light generated from the optical units LSU may not leak to the outside. That is, an amount of light provided to the light guide plate 220 from the light source units LSU may increase. Accordingly, of the light provided to the display panel 100 may be improved in efficiency.

The display apparatus of the inventive concept may reduce the bezel area.

Although a preferred embodiment of the inventive concept has been disclosed, various changes and modifications may be made thereto by one skilled in the art without departing from the scope and spirit of the invention as set forth in the appended claims. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

What is claimed is:

1. A display apparatus comprising:
a display panel displaying an image;
a light source generating light;
a light guide plate receiving the light from the light source to guide the light to the display panel; and
a heat dissipation member disposed adjacent to a side surface of the light guide plate,
the heat dissipation member comprising an insertion part passing through the heat dissipation member to accommodate the light source and provide the light generated from the light source to the light guide plate.

2. The display apparatus of claim 1, the insertion part extending along a side surface of the light guide plate.

3. The display apparatus of claim 2, the light source comprising:
a light source substrate disposed adjacent to a side surface of the light guide plate to extend along a side surface of the light guide plate; and
a plurality of light source units mounted on the light source substrate.

4. The display apparatus of claim 3, the insertion part comprising:
an accommodation groove in which the light source substrate is mounted;
a first hole formed in the accommodation groove and the light source units are inserted in the first hole; and
a second hole connected to the first hole to provide the light provided from the light source units to the light guide plate.

5. The display apparatus of claim 4, the heat dissipation member comprising:
a first extension part extending upward; and
a second extension part extending horizontally from a lower end of the first extension part,
the first extension part and the second extension part extending in a first direction along a side of the light guide plate, and
the insertion part passing through the first extension part of the heat dissipation member in a second direction that is perpendicular to the first direction and horizontal.

6. The display apparatus of claim 5, further comprising a reflection sheet disposed below the light guide plate to reflect light emitted to a lower side of the light guide plate upward.

7. The display apparatus of claim 6, further comprising an optical member disposed above the light guide plate to diffuse and collect the light provided from the light guide plate, thereby providing the light to the display panel.

8. The display apparatus of claim 7, further comprising an accommodation member accommodating the light source, the light guide plate, the heat dissipation member, the optical member, and the reflection sheet.

9. The display apparatus of claim 8, the accommodation member comprising:
a bottom part disposed below the reflection sheet; and
a plurality of sidewall parts connected to the bottom part,
the light source and the heat dissipation member being disposed on an inner side surface of one of the sidewall parts.

10. The display apparatus of claim 9, the light source units being mounted on a front surface of the light source substrate, which faces a side surface of the light guide plate, and a rear surface of the light source substrate contacts an inner surface of one of the sidewall parts of the accommodation member.

11. The display apparatus of claim 10, further comprising a mold frame disposed above the light guide plate and the heat dissipation member and having a frame shape surrounding edge areas of an optical member and the display panel,
the optical member and the display panel being seated inside the frame shape of the mold frame.

12. The display apparatus of claim 11, the mold frame comprising:
a first vertical part contacting the sidewall part of the accommodation member to extend along the sidewall part;
a second vertical part disposed below the first vertical part to extend parallel to the first vertical part;
a first horizontal part connected to a lower end of the first vertical part and an upper end of the second vertical part to extend horizontally along the sidewall part of the accommodation member; and
a second horizontal part connected to a lower end of the second vertical part to extend horizontally along an edge of a top surface of the light guide plate,
the first vertical part, the second vertical part, the first horizontal part, and the second horizontal part being connected to form a stair shape,
the display panel being seated on a top surface of the first horizontal part, and
the optical member being seated on a top surface of the second horizontal part.

13. The display apparatus of claim 11, further comprising a cover member disposed above the display panel,
the cover member comprising:
a first cover part surrounding an edge area of the display panel;
a second cover part connected to the first cover part to surround the sidewall parts of the accommodation member; and
an open part disposed inside the first cover part to expose the display area of the display panel,
the first cover part being connected to the second cover parts to form the frame shape surrounding the display panel, the backlight unit, the mold frame, and the accommodation member.

14. The display apparatus of claim 11, the heat dissipation member being connected to the mold frame to form one body.

15. The display apparatus of claim 4, the second hole gradually increasing in size in a vertical direction from the light source unit toward the light guide plate.

16. The display apparatus of claim 3, the heat dissipation member comprising:
an accommodation groove in which the light source substrates are mounted;
a plurality of first holes formed in the accommodation groove, disposed to be spaced apart from each other by a same distance along a side of the light guide plate, and the light source units are inserted into the plurality of first holes; and
a second hole connected to the first holes to provide light provided from the light source units to the light guide plate,
the accommodation groove, the first holes, and the second hole are connected to each other to pass through the heat dissipation member.

17. The display apparatus of claim 1, the heat dissipation member comprising metal.

18. The display apparatus of claim 1, a damage prevention tape being attached between the light guide plate and the heat dissipation member.

19. A display apparatus comprising:
a display panel displaying an image;
a plurality of light sources generating light, the light sources are mounted on a front surface of a light source substrate;
a light guide plate receiving the light from the light source to guide the light to the display panel; and
a heat dissipation member disposed adjacent to a side surface of the light guide plate,
the heat dissipation member comprising one insertion hole, the plurality of light sources passing through the insertion hole so as to be accommodated in the insertion hole while the light source substrate do not pass through the insertion hole, the light sources provides the light generated from the light source to the light guide plate.

20. The display apparatus of claim 19, the insertion hole surrounding the plurality of light sources.
